(19) United States
(12) Patent Application Publication
(10) Pub. No.: US 2025/0242477 A1
(43) Pub. Date: Jul. 31, 2025

(54) MOUNTING APPARATUS AND METHOD FOR POWDER COATING

(71) Applicant: Jonathan Henry Miller, Sandy, UT (US)

(72) Inventor: Jonathan Henry Miller, Sandy, UT (US)

(21) Appl. No.: 19/042,522

(22) Filed: Jan. 31, 2025

Related U.S. Application Data
(60) Provisional application No. 63/627,365, filed on Jan. 31, 2024.

(51) Int. Cl. B25B 11/00; B05D 1/06

(52) U.S. Cl. CPC B25B 11/002; B05D 1/06

(57) ABSTRACT

A mounting method and apparatus for power coating utilizes magnetic attraction to hold small magnetic objects during the powder coating process. The strength of the magnetic force is sufficient to hold the small objects on a grounded sheet or tray while as the same time not sufficient to disrupt the attraction of the powder particles to the objects. A matrix of magnets may provide an adequate magnetic field, as could a variable strength electromagnet. The method and apparatus may be adapted to provide a powder coating chamber for use with various articles.

### CROSS-REFERENCES TO RELATED APPLICATIONS

The present invention claims priority as a non-provisional perfection of prior filed U.S. Application No. 63/627,365, filed on Jan. 31, 2024, and incorporates the same by reference herein in its entirety.

### FIELD OF THE INVENTION

The present invention relates to the field of powder coating and more particularly relates to a mounting apparatus with particular usefulness for the powder coating of small articles.

### BACKGROUND OF THE INVENTION

The powder coating process is used to cover an item with a durable polymer. While not as durable as a ceramic coating, powder coating can provide an even, professional, resistant coating that will resist higher temperatures than paint. Polymer powder is imparted with an electrostatic charge which draws airborne powder particles towards a grounded, conductive, article. The powder particles adhere to the article due to the electrostatic charge and tend to efficiently cover the article on all sides, with the particles flowing towards and into various nooks, crannies, edges, and corners of the article due to the provided charge. Once coated sufficiently with the powder, the article is set in an oven or other heating apparatus, typically set in a range of 400 to 450° F. (˜205 to ˜232° C.) and heated until the polymer flows and is eventually cured in place. Typical powders used in powder coating are comprised of polyesters, polyurethanes, acrylics, fluoropolymers, epoxies, and polyester-epoxy blends. Powder coating has a number of advantages over other coating methods as it does not utilize a solvent or carrier, as would paint or ceramic coatings, which then must evaporate out of an applied suspension. Not only does this lack of a solvent result in fewer volatile organic compounds (VOCs) being released into the atmosphere, but the process is also very forgiving if a mistake is made in the coating process. Uncured powder may simply be blown off of the article with an air compressor and even an article with an errant cured coat may simply be recoated as the electrostatic charge is still sufficient to attract powder to the article even after one or more powder coating treatments.

For classic powder coating, it is necessary that the article to be coated can carry an electrical charge. The article is typically grounded to the spray gun, which imparts a charge on the powder particles as they are expelled. This then causes the charged particles to stick to the article. Typically, an article is hung on some form of grounded framework, or if it is capable of being set on the ground, it may be placed on a grate or pedestal with the ground being through said grate or pedestal or through itself.

While powder coating is a preferred manner of coating larger articles, there can be difficulties when attempting to coat small (less than 1 in² or 6.45 cm²) items. Smaller items are harder to anchor and ground as the anchors cover more and more of their surface area. Exceptionally smaller items may also be moved by the light pressure caused by the blowing powder or even be lost in the powder. These limitations curtail the effectiveness and desirability of using powder coating for such small items. What is needed, then, is a system, method, and apparatus that will sufficiently anchor very small items in a manner that will allow such items to maintain both position and grounding for powder coating to work more effectively with them.

The present invention is a grounding plate positioned within a magnetic field which may hold not only these very small articles but may also be scaled upward to be used with small and larger articles. The present invention represents a departure from the prior art in that the system and method of the present invention allows for small ferromagnetic, ferrimagnetic, or other magnetically active articles to be effectively anchored and grounded for powder application.

Likewise, this invention may be utilized in any finishing procedure which utilizes any type of electromagnetic attraction to cover an article in some form of particle and may prove useful in electroplating or galvanization. While other methods of utilizing powder coating materials do exist for non-conductive articles, such as hot flocking for glass and ceramics, the electrical charge and attraction are requisite to this invention.

### SUMMARY OF THE INVENTION

In view of the foregoing disadvantages inherent in the known methods of powder coating, an improved powder coating anchoring system may provide a superior system for powder coating smaller articles that meets the following objectives: that it be simple and effective in use, that its use would be intuitive and not radically alter current powder coating practices, that it adequately anchor and maintain a ground on multiple smaller articles simultaneously, that it be scalable and effective for larger articles, and that it be cost efficient to implement As such, a new and improved may comprise a grounded metal sheet which is subjected to a magnetic field which will secure articles which a user desires to powder coat in order to accomplish these objectives. Other embodiments of the invention include chambers in which these grounded metal sheets may be placed for powder coating and, possibly, subsequent curing. The use of the chamber device allows for an automated powder coating chamber that provides an all-in-one, push-button solution for coating arrays of large or small articles. The chamber can either include heating elements to cure the powder coating in situ, or the tray securing the articles can be removed to be placed in a separate oven. In the case that the curing occurs in the chamber itself, proper construction allows for traditional methods of powder coat removal in periodic cases of excess coating build-up. This includes, but is not limited to, chemical stripping, sand-blasting, or elevated temperature bake-out. If necessary, seals and flanges may be replaced with modest effort and cost.

The more important features of the invention have thus been outlined in order that the more detailed description that follows may be better understood and in order that the present contribution to the art may be better appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a perspective view of one embodiment of the mounting apparatus.

FIG. 2 is a perspective view of the mounting apparatus of FIG. 1 in use.

FIG. 3 is a perspective view of the mounting apparatus of FIG. 2, after use and prior to removal of the target articles.

FIG. 4 is an exploded view of the mounting apparatus of FIG. 1.

FIG. 5 is a perspective view of the magnet matrix tray of FIG. 4.

FIG. 6 is a perspective view of an alternate embodiment of the mounting apparatus, utilizing an electromagnet.

FIG. 7 is a partial transparent perspective view of an embodiment of a powder coating chamber.

FIG. 8 is an alternate perspective view of the powder coating chamber of FIG. 7.

FIG. 9 is another alternate perspective view fof the powder coating chamber of FIG. 7.

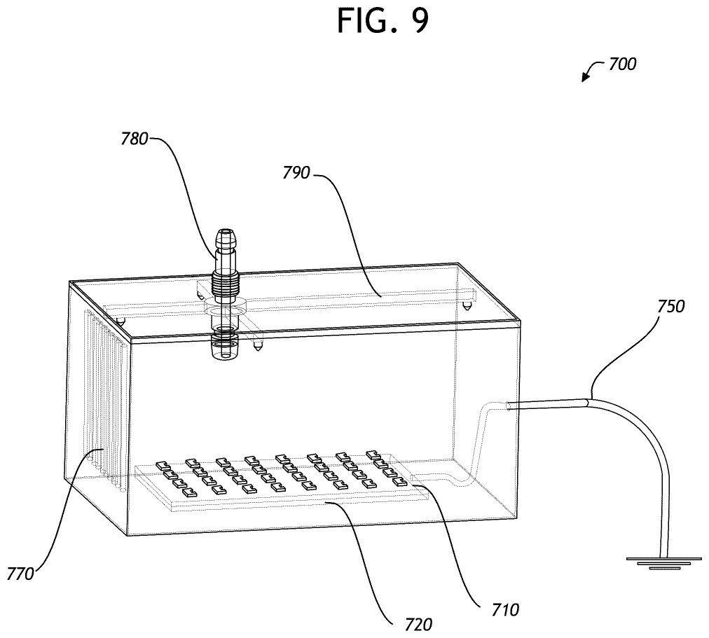

FIG. 10 is another alternate perspective view of the powder coating chamber of FIG. 7, with the sprayer assembly removed and a lid provided.

FIG. 11 is an alternate embodiment of a powder coating chamber.

FIG. 12 is a side elevation of the powder coating chamber of FIG. 11.

FIG. 13 is a top plan view of the powder coating chamber of FIG. 11, prepared for curing.

FIG. 14 is another alternate powder coating chamber, utilizing a kiln for curing.

### LISTING OF REFERENCE NUMERALS

10—mounting apparatus;
20—mounting surface sheet;
30—button magnets;
40—magnet matrix tray;
50—ground;
60—articles for powder coating;
70—powder coating applicator;
110—alternate mounting apparatus;
120—mounting surface sheet;
130—electromagnet;
140—partition;
150—ground;
160—additional articles for powder coating;
700—a powder coating chamber;
710—mounting apparatus;
720—pedestal assembly;
750—ground;
760—articles for powder coating;
770—heating element;
780—powder spray nozzle;
790—nozzle tracks;
800—alternate powder coating chamber;
810—alternate mounting apparatus;
820—alternate pedestal assembly;
830—upper chamber wall;
870—heating element;
880—powder spray nozzle;
890—nozzle socket plug;
900—powder coating apparatus without internal heating assembly; and
910—kiln.

### DESCRIPTION

With reference now to the drawings, a preferred embodiment of the mounting apparatus and method for powder coating is herein described. It should be noted that the articles “a”, “an”, and “the”, as used in this specification, include plural referents unless the content clearly dictates otherwise.

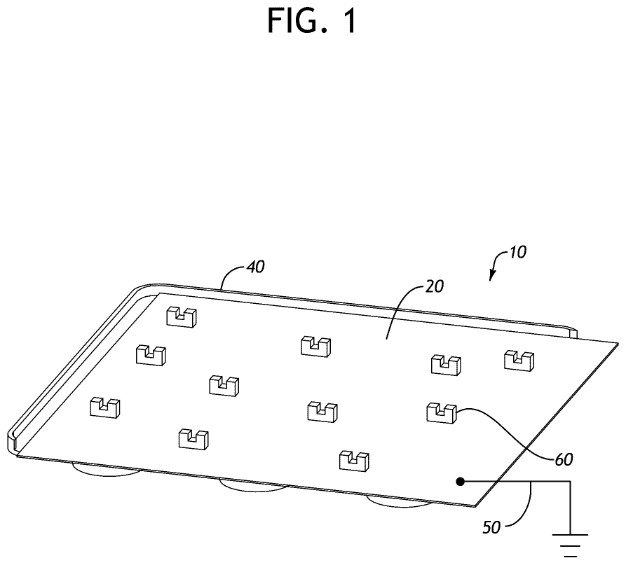

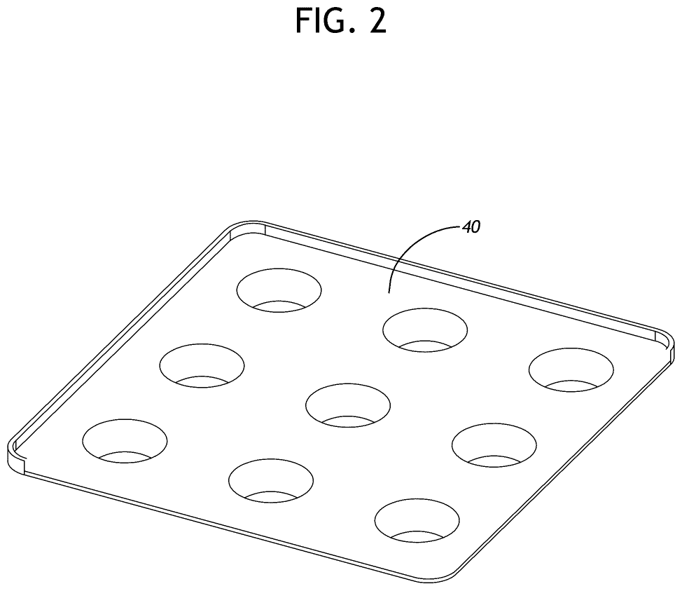

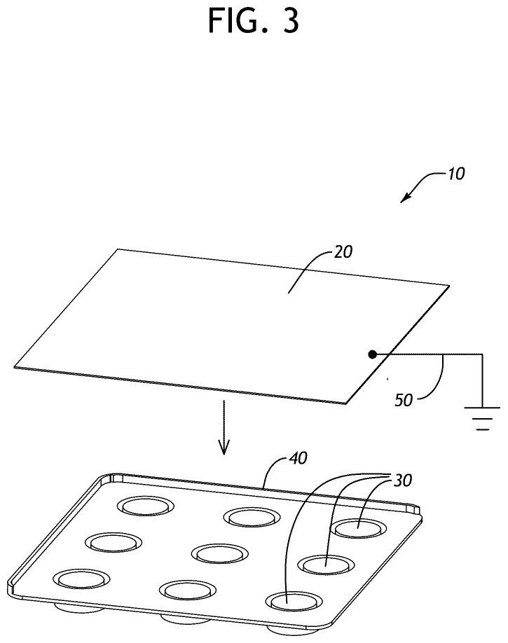

With reference to FIG. 1, an embodiment of the invention may be achieved by placing a ferrous mounting sheet 20 over a matrix of neodymium or AlNiCo button magnets 30 secured in a tray which holds them in a regular matrix 40. The magnets 30 will then provide a uniform magnetic field potential across the surface area of the mounting sheet 20. Once mounting sheet 20 is grounded 50, the articles desired to be powder coated 60, such as the brackets for dental braces illustrated in the figures, may be positioned upon the mounting sheet 20. By magnetically mounting the articles 60, they are provided the same ground 50 as the mounting sheet 20 and there are no clips, hooks, or other objects with which to interfere with the coating process. Then, powder coating may be applied 70 to the articles 60 (FIG. 2) though a gentle airstream. The powder particles are electrically charged by the applicator 70 (which may be positive or negative) and will be drawn to the grounded mounting sheet 20 and the articles 60 mounted thereon. Powder particles are not, however, affected by the magnetic field and will continue to be attracted to the grounded items. When finished (FIG. 3), the mounting sheet 20 may be removed and taken out of the magnetic field, and the articles 60 removed therefrom.

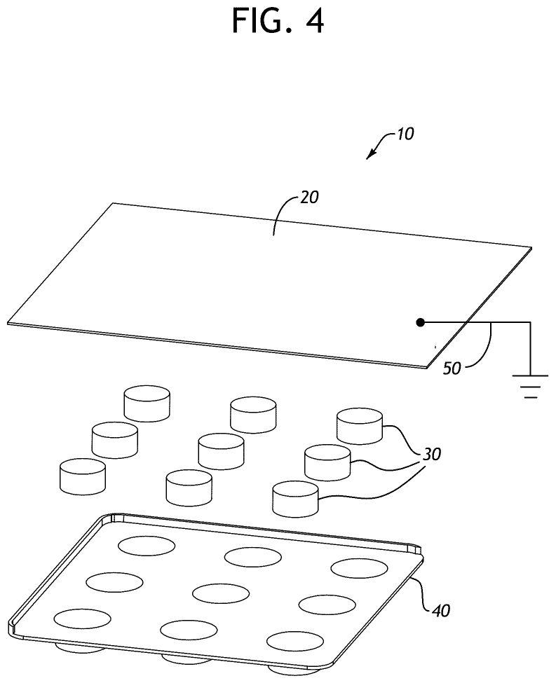

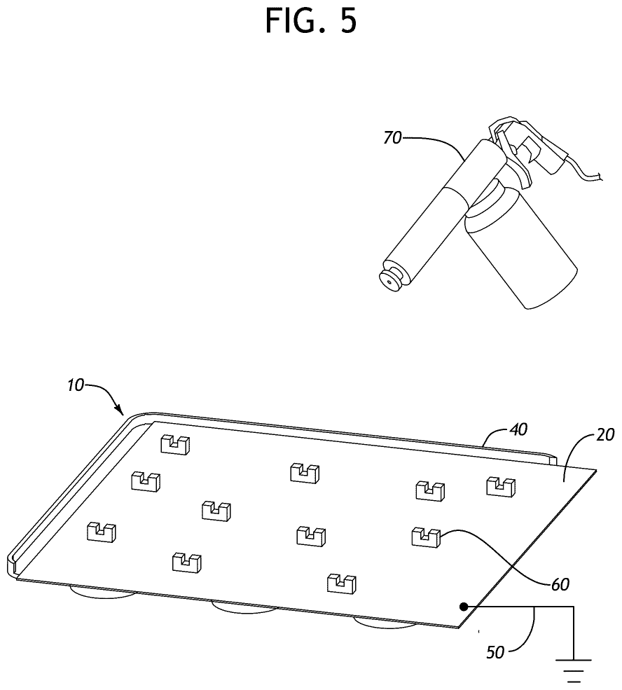

There are many ways to accomplish the magnetic mounting of the articles 60. In what is perhaps the simplest embodiment, a magnetic matrix tray 40 holds a plurality of neodymium magnets 30 underneath the mounting sheet 20 (FIG. 4). This tray 40, shown in greater detail in FIG. 5, simply provides a divot 45 in which each magnet 30 may reside. The divots 45 are present in regular intervals providing the structure to maintain the magnetic matrix, and the resultant regular, uniform, magnetic field. Modification may be made to the tray 40, such as encapsulating each magnet 30 in each divot 45 (not shown). While the mounting sheet 20 will effectively seal off the magnets 30 from applied powder and help hold the magnets 30 in their divots 45, eventually the mounting sheet 20 must be removed (FIG. 3) and, if not encapsulated, magnets 30 may tend to maintain contact with the mounting sheet 20, rather than stay in the tray 40. Powder will also be free to move after the mounting sheet 20 is no longer grounded and may accidentally flow into the matrix tray 40. Therefore, encapsulation of the magnets 30 is preferred.

The type and size of magnets are variable with the desired application. The invention is particularly well suited to the securement of small objects, such as the illustrated brace brackets. Stainless steel brace brackets typically have widths less than 0.2 inches (5 mm) and weigh about 0.004 oz. (0.13 grams). Creating a 9 or 16-magnet matrix of even very small magnets, such as neodymium button magnets with 0.6 inch (1.5 mm) diameters and 1.59 oz (45 g) pull forces, will be sufficient to secure enough of such brackets to provide a customized powder coating of these brackets for a single patient. Larger numbers of objects, or larger sized objects, would require a larger matrix and/or stronger magnets as appropriate to the project. For instance, a matrix of AlNiCo magnets having diameters of about 0.33 inches (7.5 mm) and sufficient depth to provide 3 lbs. (1.36 kg) pull force would be adequate for most small scale purposes without making it overly difficult to remove much smaller objects, like the aforementioned brace brackets. While illustrated with rare earth disk magnets, it should be recognized that other magnet shapes, such as rings or blocks, and types exist which may be used in this method and apparatus and that various sheets and tray sizes would easily be made to accommodate them. Nothing in this exemplary use should be seen as limiting either the size or number of objects or magnets utilized in the practice of the invention.

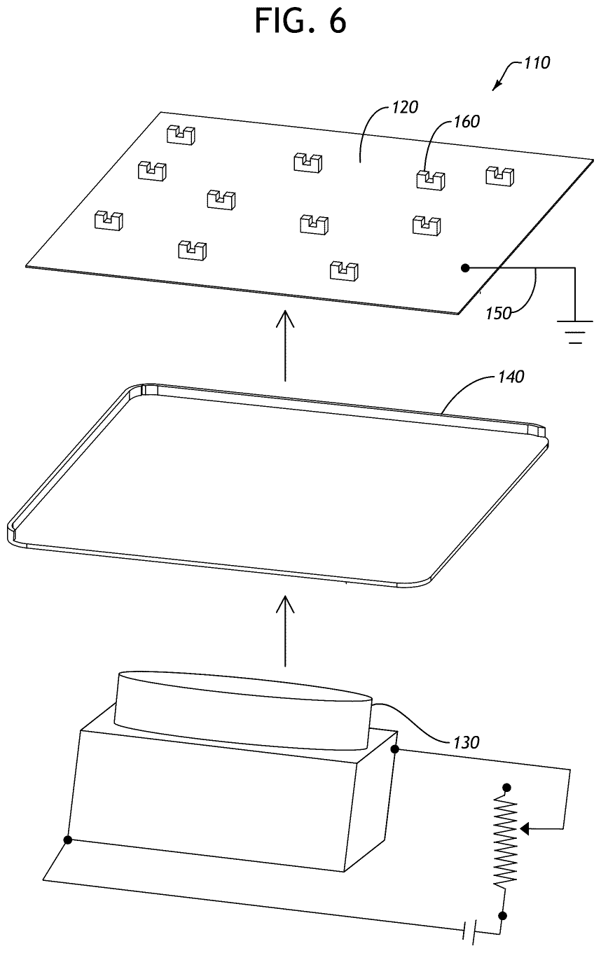

Another type of magnet which may be utilized is an electromagnet 130, such as the one illustrated in FIG. 6. Such an assembly 110 could be made without the need of a magnet matrix tray, as the electromagnet 130 may be placed directly against the mounting surface 120, or underlying surface or partition 140 (such as the floor of a chamber in which the articles are mounted), which could be separately grounded 150 or grounded through the structure of the electromagnet 130 itself. In this embodiment, the electromagnet may simply be turned on or off to generate the magnetic field and secure the articles 160. Variable strength electromagnets can be used to increase or decrease the magnetic field without the need of various matrix trays or other electromagnets. One or more electromagnets may also be used for even larger applications.

The tray assembly, and other embodiments thereof, may be incorporated into a powder coating chamber which will prove suitable for individualized batches of parts in an array. The parts in question may be small, such as braces brackets, or even larger. As such, while no size limitation should be read into the appended claims, the preferred embodiment does contemplate batches of smaller objects arranged in an array, coated with powder, and then heat cured in the same container in an office setting. In these embodiments, the choice of a magnet must be limited to those that can withstand the higher temperature of the curing process. Neodymium magnets may begin to degauss at temperatures in the range of 176-212° F. (80-100° C.), well below the melting point of most power coating. Therefore, magnets which can withstand higher temperatures, such as those made of AlNiCo or samarium cobalt, or an electromagnet made of materials designed to withstand the heating process, whether by their inherent nature or by protective insulation, should be used in these chambers. Alternatively, the mounting sheet may be removed from the assembly and transferred into an oven, kiln, or other heating chamber.

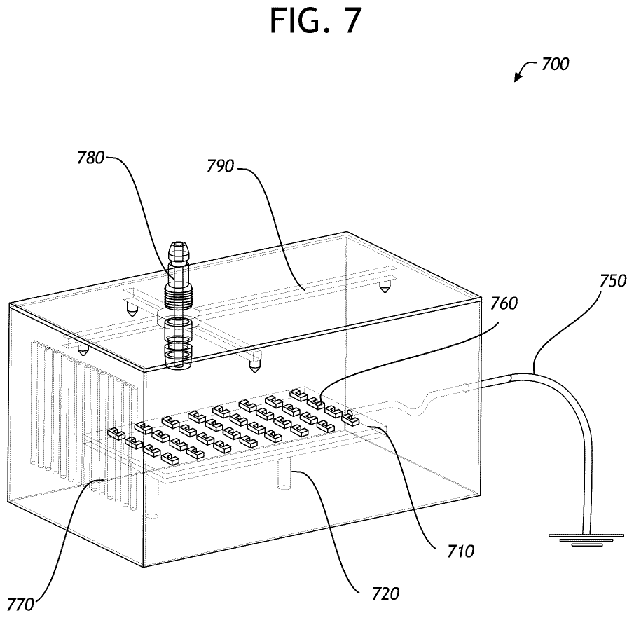

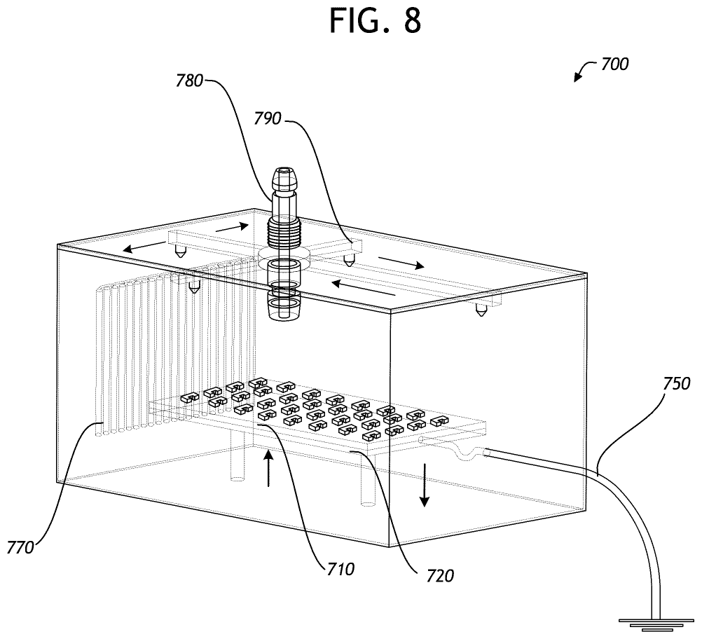

As shown in FIG. 7, a mounting apparatus 710 resides on a pedestal 720 within a coating chamber 700. The apparatus 710 is grounded 750 and holds various articles 760 in preparation for powder coating. The magnetic force may be provided by either an underlying tray of heat resistant magnets within the pedestal or an electromagnet which may be powered by a cable similar to the ground. At least one heating source 770 is present within the chamber 700 as is a power spray nozzle 780. The depicted nozzle 780 resides on tracks 790 and is motor driven to traverse the X and Z axes while the pedestal 720 traverses the Y axis (FIG. 8). This allows the articles 760 to be evenly coated before heating. This embodiment features three axes of movement and it is readily seen that this range of motion may be further modified to allow for only two axes or up to five axes of movement for stand-off distance, planar movement and two axes of rotation. Powder application may be made in a closed environment with a lid or a semi-closed environment without one.

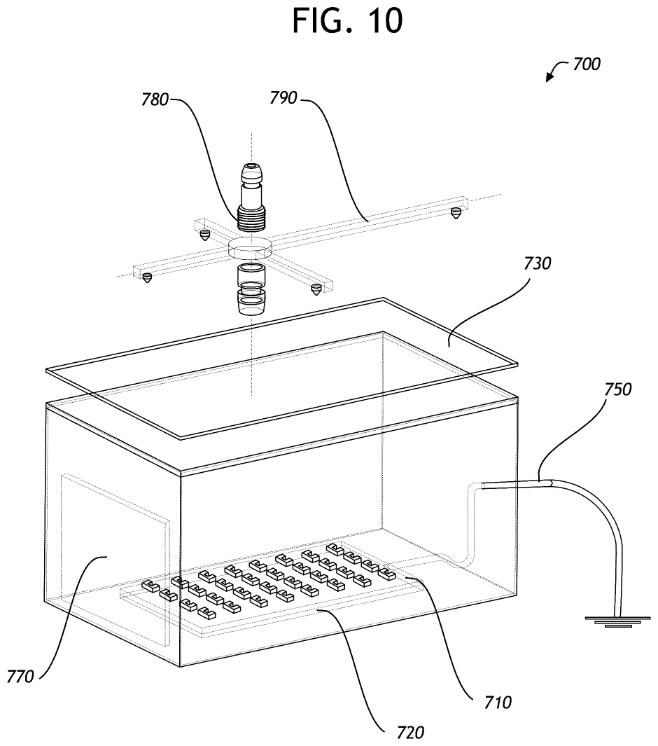

After coating, excess powder may be removed and the chamber heated to melt and cure the applied powder. Before this stage, various embodiments envision the removal of powder from the system before curing. In the depicted embodiment with a semi-open chamber, the coating apparatus may be removed from the chamber and a lid 730 secured above (FIG. 10). In another, the nozzle alone may be removable from the apparatus. In either case, this removes the nozzle from proximity with the heat source and prevents powder from curing and clogging the nozzle. Once the nozzle is removed, the heating elements are activated to cure powder.

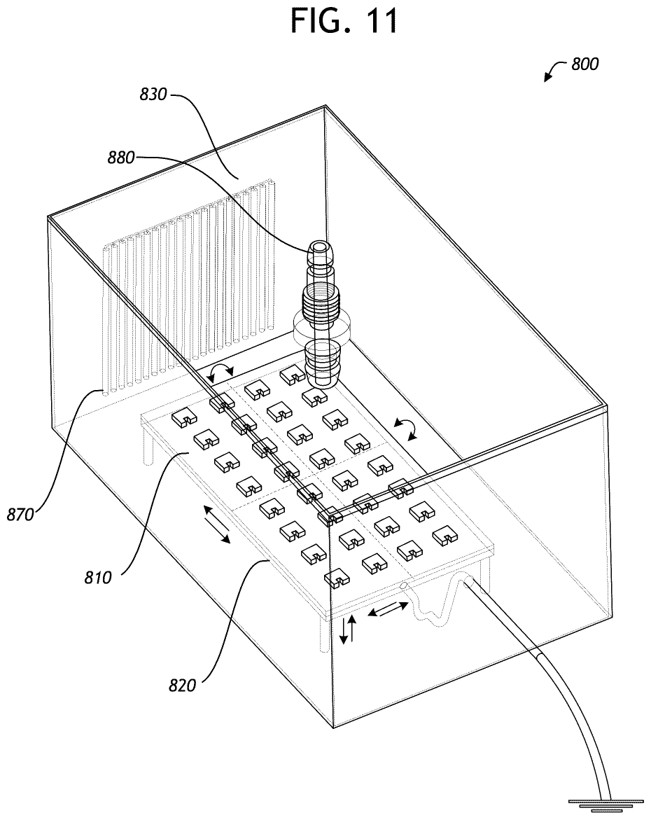

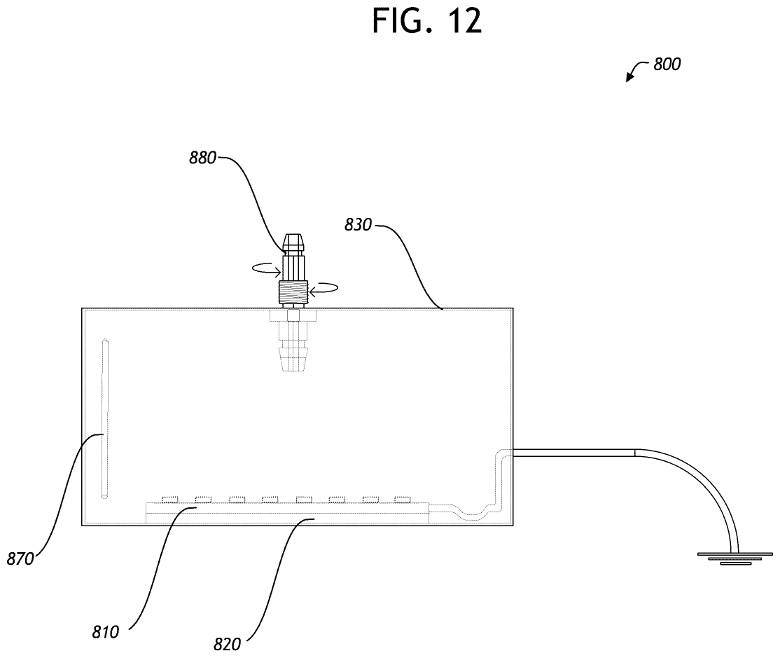

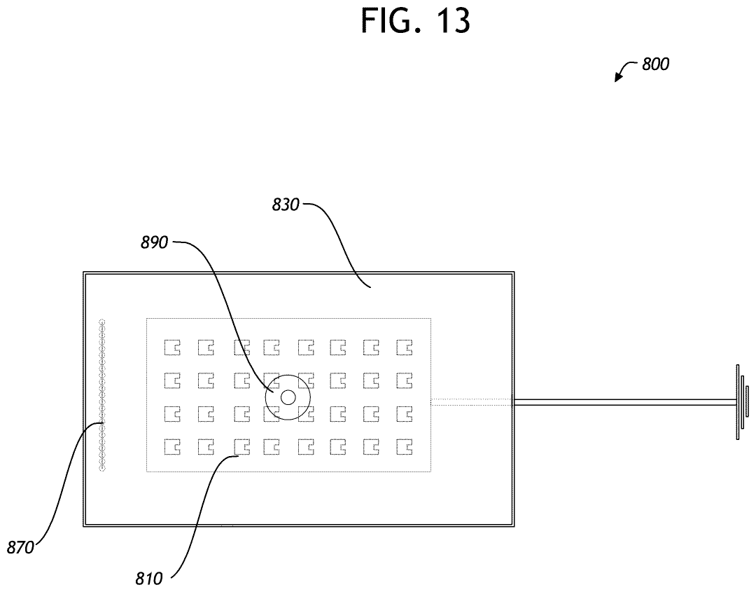

In another embodiment 800, shown in FIGS. 11-13, the pedestal 820 is made to move in all axes, rather than the nozzle 880. This causes the same efficient coating effect but centralizes the motive sources, attaching them to the pedestal 820. For this embodiment, it is preferred that the lid be affixed to the chamber and provide a static support, like the upper chamber surface 830 for a removable nozzle, which may then be replaced by a sealing, heat resistant plug 890 (FIG. 13).

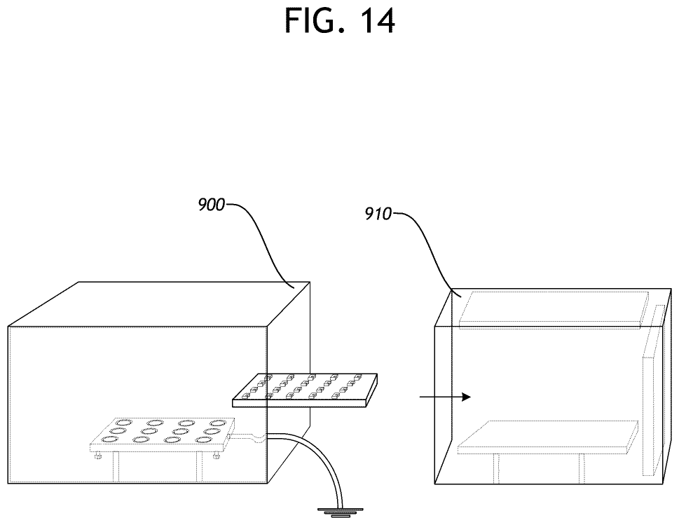

After curing, the articles may be removed and the chamber, if not cleared before, cleared of cured powder. This cleaning step may be accomplished by removing the tray after powder is applied to the articles and placing the tray in a separate oven, kiln or other heating apparatus 910 (FIG. 14).

Although the present invention has been described with reference to preferred embodiments, numerous modifications and variations can be made and still the result will come within the scope of the invention. The embodiments described are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

What is claimed is:

1. An assembly for securing an array of magnetically active objects for powder coating, the assembly comprising:
a grounding sheet actively connected to a ground, said sheet having upper and lower surfaces; and
a source of a magnetic field underlying the grounding sheet, the provided magnetic field about the grounding sheet;
wherein magnetically active objects are positioned and secured on the upper surface of the grounding sheet within the magnetic field in preparation for powder coating, the grounding sheet having a common ground with a powder spraying apparatus.

2. The assembly of claim 1, further comprising:
a chamber about the grounding sheet and source of magnetic field;
a nozzle mounted within the chamber and in communication with a powder supply for powder coating; and
a plurality of motors connected to move the nozzle relative to the grounding sheet.

3. The assembly of claim 2, further comprising at least one heating element resident within the chamber.

4. The assembly of claim 3, the nozzle being removable from the assembly before a heating cycle is activated.

5. The assembly of claim 2, at least two of the plurality of motors being operatively connected to a pedestal on which the grounding sheet is positioned and providing movement along at least two axes.

6. The assembly of claim 5, further comprising at least one heating element resident within the chamber.

7. The assembly of claim 6, the nozzle being removable from the assembly before a heating cycle is activated.

8. The assembly of claim 1, the source of magnetic field being an electromagnet.

9. The assembly of claim 8, further comprising:
a chamber about the grounding sheet and source of magnetic field;
a nozzle mounted within the chamber and in communication with a powder supply for powder coating; and
a plurality of motors connected to move the nozzle relative to the grounding sheet.

10. The assembly of claim 8, further comprising at least one heating element resident within the chamber.

11. The assembly of claim 10, the nozzle being removable from the assembly before a heating cycle is activated.

12. The assembly of claim 8, at least two of the plurality of motors being operatively connected to a pedestal on which the grounding sheet is positioned and providing movement along at least two axes.

13. The assembly of claim 12, further comprising at least one heating element resident within the chamber.

14. The assembly of claim 13, the nozzle being removable from the assembly before a heating cycle is activated.

15. The assembly of claim 1, the source of magnetic field being a plurality of magnets arranged in a matrix.

16. The assembly of claim 15, further comprising:
a chamber about the grounding sheet and source of magnetic field;
a nozzle mounted within the chamber and in communication with a powder supply for powder coating; and
a plurality of motors connected to move the nozzle relative to the grounding sheet.

17. The assembly of claim 16, further comprising at least one heating element resident within the chamber.

18. The assembly of claim 12, the at least one of the motors being operatively connected to a pedestal on which the grounding sheet is positioned and providing movement alone at least two axes.

19. The assembly of claim 18, further comprising at least one heating element resident within the chamber.

20. The assembly of claim 18, further comprising a separate heating structure, into which the grounding sheet is moved after powder coating is applied to the magnetically active objects.
